(19) United States
(12) Patent Application Publication
(10) Pub. No.: US 2007/0202850 A1
(43) Pub. Date: Aug. 30, 2007

(54) Cost estimation in messaging application for a mobile communication device

(75) Inventors: Brett Anthony Pantalone, Pittsboro, NC (US); Yojak Vasa, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/363,141

(22) Filed: Feb. 27, 2006

(51) Int. Cl. H04Q 7/22

(52) U.S. Cl. 455/412.1

(57) ABSTRACT

A messaging application for a mobile communication device comprises an integrated message composer for creating messages of two or more different types, and a cost estimation function for estimating the cost of messages based on the message type and cost data stored in memory and for providing the estimated cost of the message to the user before the message is sent. Providing the user with information about the cost of the message gives the user confidence that messages will not be undesirably expensive and the increased confidence in the cost of messages will encourage use of messaging services.

### BACKGROUND

The present invention relates generally to messaging applications for mobile communication devices, and more particularly, to an integrated messaging application capable of sending text messages, multimedia messages, email messages and instant messages.

Mobile communication devices, such as cellular telephones, offer customers a wide variety of messaging services, enabling customers to send and receive text messages, multimedia messages, email messages and instant messages. To facilitate ease of use, the current trend is to integrate some or all of the available messaging applications into a single integrated application with a common composer for creating messages. The common composer typically includes a set of editing tools for creating and sending messages. The user can thus use the same interface and a consolidated set of editing tools to create different types of messages.

Cellular operators and service providers often have different charging schemes for different types of messages. For example, a service provider may charge on a per message basis for SMS text messages, a flat monthly fee for email, and a cost per bit for multimedia messages. When using an integrated message composer, the user may not realize what type of message the user is creating. Since there may be a substantial cost difference between different types of messages, the user may unknowingly incur undesired expenses to send a message that would have been substantially cheaper using a different service. For example, a simple SMS text message intended for a relatively inexpensive transport may unwittingly become a more expensive multimedia message when the user attaches a sound file or image. Thus, while the integrated message composer is intended as a convenience for the user, it may cause confusion and worry about the cost of messages being sent.

### SUMMARY

The present invention relates to a messaging application that provides the user with information about the type and cost of messages to be sent. In one exemplary embodiment, the messaging application includes a common composer for creating messages of two or more different types. For example, the common composer application may be used to create simple text messages, email messages, instant messages, and multimedia messages. The messaging application includes a cost estimation function for estimating the cost of a message and indicating the estimated costs of the message to the user before it is sent. The estimated cost may be displayed to the user in a portion of an application window for the message composer. For example, the type and cost of the message can be displayed to the user in a title bar, menu bar, or status bar of an application window. The estimated cost of the message could also be presented to the user in a pop-up window, such as a message box or dialog box. The pop-up window may prompt the user to confirm a previous command to send a message so that the user does not inadvertently send an undesirably expensive message. The user is thus given an opportunity to edit the content of the message before it is sent such that a cheaper transport can be used to send the message if desired. By giving users confidence in the cost of messages being sent, the present invention may encourage otherwise hesitant users to send messages without fear that the messages will incur undesired expenses.

### BRIEF DESCRIPTION OF THE DRAWINGS

FIG. 1 is a functional block diagram of a messaging application for a mobile communication device according to one exemplary embodiment.

FIG. 2 illustrates an exemplary GUI for a message composer displayed on a mobile communication device.

FIG. 3A illustrates an exemplary GUI for a message composer displayed on a mobile communication device.

FIG. 3B illustrates an exemplary GUI for a message composer displayed on a mobile communication device.

FIG. 4 illustrates an exemplary GUI for a message composer displayed on a mobile communication device.

FIG. 5 illustrates an exemplary GUI for a message composer displayed on a mobile communication device.

FIG. 6 is a block diagram of an exemplary mobile communication device.

FIG. 7 illustrates an exemplary cost table embodied in XML code.

### DETAILED DESCRIPTION

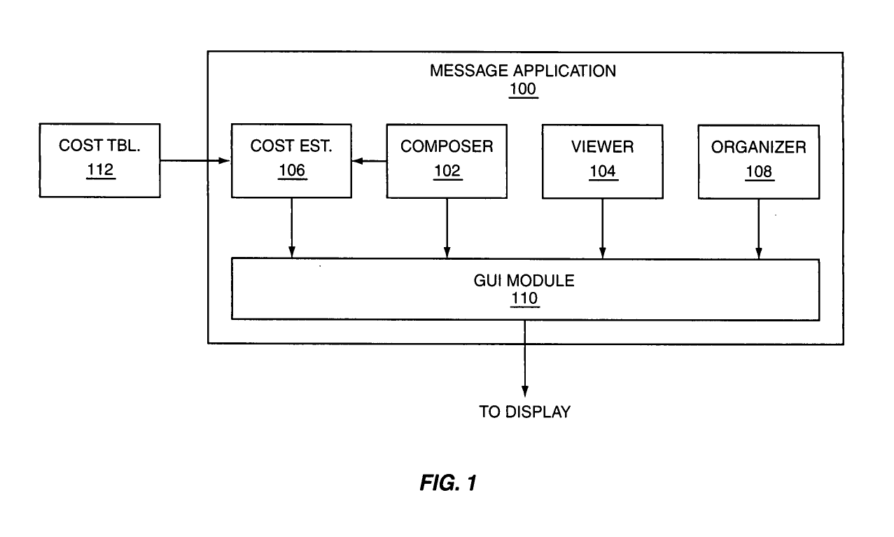

FIG. 1 illustrates the main components of a messaging application 100 for a mobile communication device 10. The messaging application 100 includes a message composer 102, a message viewer 104, a cost estimation function 106, an organizer 108, and a graphical user interface (GUI) module 110. The message composer 102 is used to create messages to be sent. The message composer 102 provides a common interface and a common set of editing tools for creating messages of two or more different types. In one exemplary embodiment, the message composer 102 is capable of creating simple text messages, multimedia messages, instant messages and email messages. The message viewer 104 provides tools for viewing messages received by the mobile communication device 10. The cost estimation function 106 estimates the cost of messages to be sent. The cost estimation function 106 receives information from the message composer 102 about the type, size and content of messages. The cost estimation function 108 also has access to cost information stored in a cost table 112 in the memory of the mobile communication device 10. The organizer 108 provides a set of management tools to manage messages sent and received. The GUI module 110 creates a GUI for the components of the messaging application 100 that is presented to the user on a display 40 of the mobile communication device 10. In the exemplary embodiment, the GUI is a conventional windowing interface. Those skilled in the art will appreciate, however, that the nature of the software interface is not a material part of the invention and that other types of interfaces may be used with the present invention, including command line interfaces and other types of GUI interfaces.

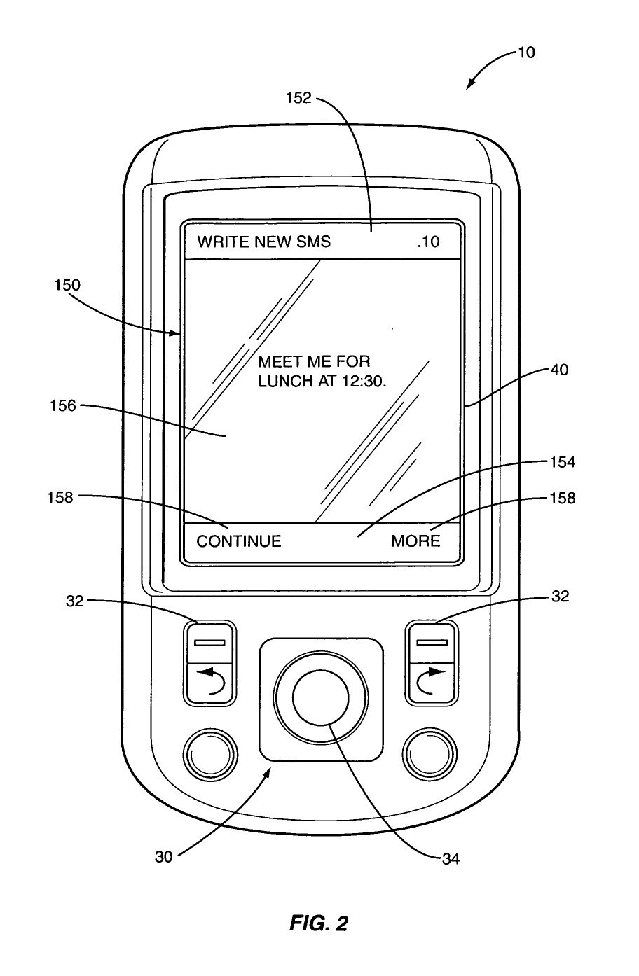

FIGS. 2-5 illustrate a GUI for the message composer 102 as it appears on the display 40 of the mobile communication device 10. The GUI for the message composer 102 comprises an application window 150 having a title bar 152 at the top of the window 150, a menu bar 154 at the bottom of the window, and a message field 156 where the message being composed is displayed. In this example, the message field 156 displays a simple text message which the user is composing. The title bar 152 includes information identifying the type and estimated cost of the message. In this example, the information contained in the title bar 152 indicates that the message is a text message using the Short Message Service (SMS) for transport, and that the estimated cost of the message is 10 cents. The menu bar 154 at the bottom of the application window 150 includes one or more menu items 158 that can be selected by pressing the selection keys 32 adjacent to the display. A navigation control 34 is also provided to enable the user to navigate through menus and make selections.

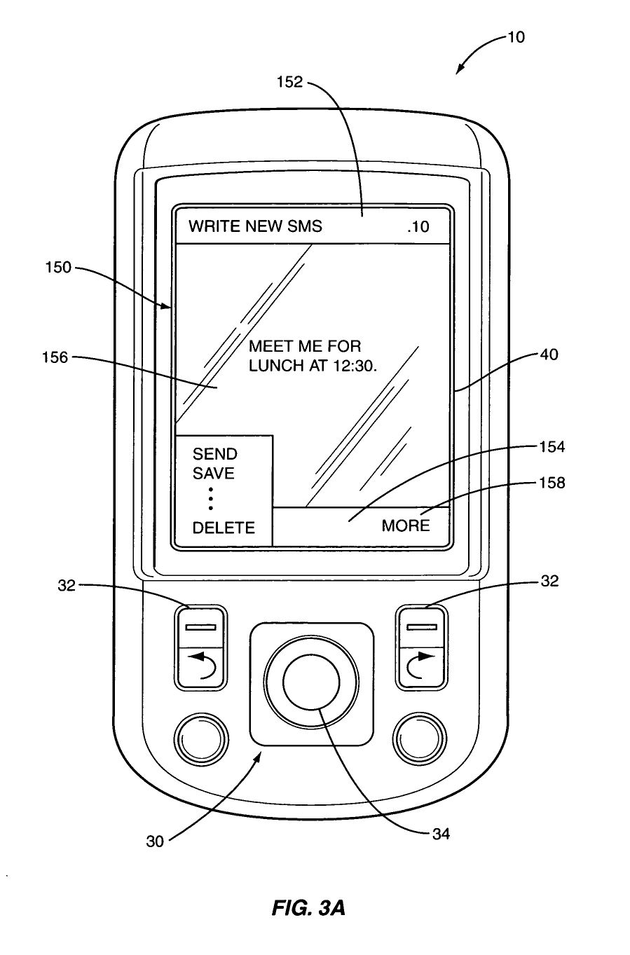

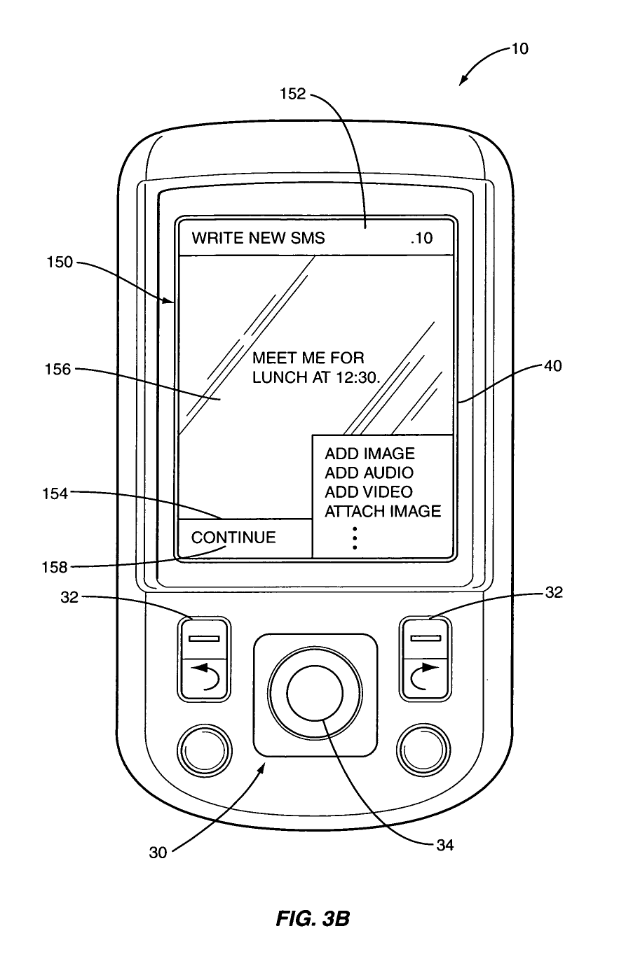

The menu bar 154 in the exemplary embodiment displays two menu items 158 that are used to access pop-up menus as shown in FIGS. 3A and 3B. The CONTINUE menu, shown in FIG. 3A, provides a list of options for handling messages, such as SAVE, SEND, and DELETE. The MORE menu, shown in FIG. 3B, provides a set of editing tools for editing messages. In this example, the editing tools allow the user to add or attach images, audio, and video to the message.

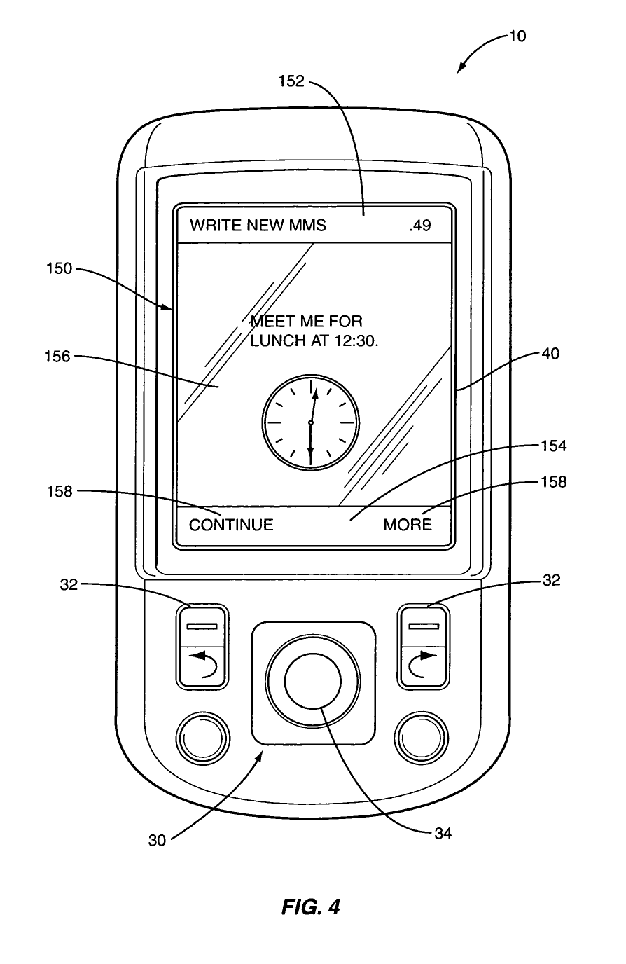

As additional content is added to the message, the type and/or cost of the message may change. Referring to FIG. 4, the user has added an image of a clock to the original text message. The information contained in the title bar 152 changes to reflect that the message type has changed. The estimated cost has also been updated. Following the addition of the image, the message has become a multimedia message using the Multimedia Messaging Service (MMS) for transport. The estimated cost of the message is 49 cents.

Providing information to the user about the type and cost of the message before it is sent provides more certainty about the cost of messages being sent. Some users that are hesitant to use messaging services because of worries about the cost of such services will be encouraged to make more use of messaging services. If a message is considered too costly, the user also has an opportunity to change the content of the message to reduce the cost before the message is sent.

In the exemplary embodiment described above, cost information is provided for individual messages and is not stored. That is, the cost information is discarded after the message is sent. In some embodiments, the messaging application 100 can store historical cost information about the cost of each message sent. Also, some embodiments may track the cumulative cost of all messages sent over a defined period of time. The cumulative cost of all messages sent over a defined period may also be displayed to the user.

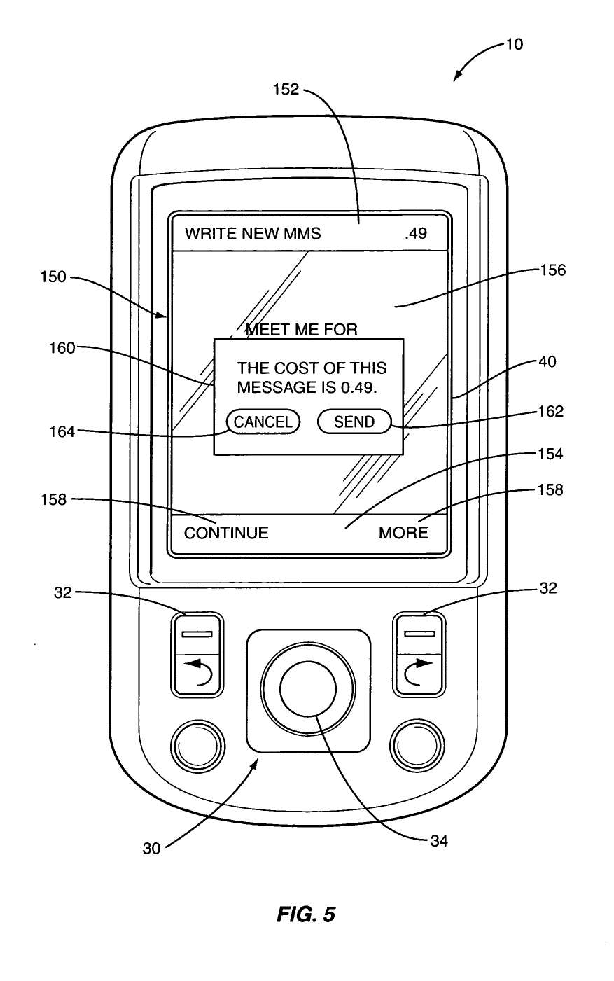

In some embodiments of the invention, the messaging application 100 may generate a pop-up window 160 before the message is sent to inform the user of the cost of the message as shown in FIG. 5. The pop-up window 160 may be displayed responsive to a request or command to send the message. The pop-up window 160 may further include a prompt requesting the user to confirm the send command. In FIG. 5, the pop-up window 160 displays information indicating the cost of the message being sent and prompts the user to confirm the send command. In this example, the pop-up window 160 includes two buttons 162, 164. Button 162 is used to confirm the send command. Button 164 is used to cancel the send command. When the send command is canceled, the message may be displayed to the user in the message composer window for editing.

The user may consider the display of the pop-up window 160 with every message to be annoying. Therefore, the messaging application 100 may allow the user to set preferences to control when the pop-up window 160 is displayed. The user preferences may permit the user to suppress the pop-up window 160 for all messages, or for some messages based on a predefined criterion. The pop-up window 160 may be suppressed depending on the type or cost of the message, the time of day, the cumulative cost of messages sent over a defined period, or other criteria. For example, the user may chose to suppress the pop-up window 160 for text messages and to enable the pop-up window 160 for all other messages. In another example, the user may select to suppress the pop-up window 160 where the cost of the individual message is less than a specified amount, e.g. 10 cents, or where the cumulative cost of all messages sent over a defined period is less than a specified amount. In other embodiments, the user may enable the pop-up window for specified times of the day when costs are high and suppress the pop-up window 160 for times of day when the rates are lower.

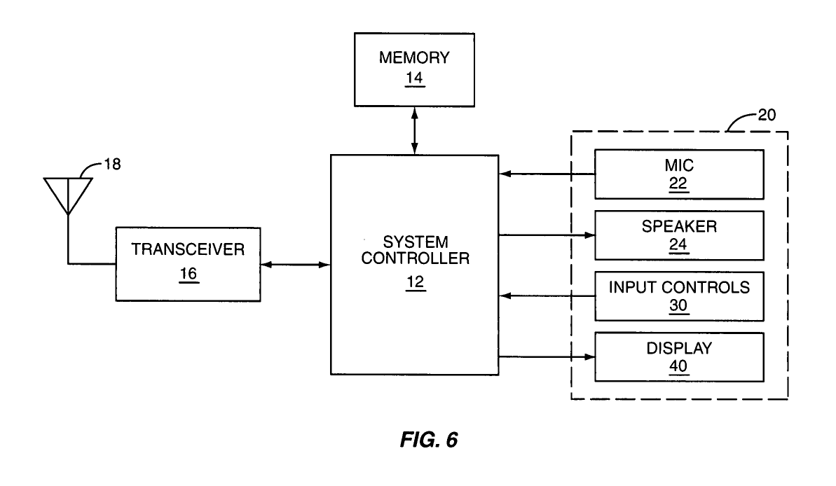

FIG. 6 is a block diagram illustrating a mobile communication device 10 in which the present invention may be implemented. The mobile terminal 10 may, for example, comprise a cellular telephone for use in a mobile communication network, a personal digital assistant (PDA), a laptop computer, or a hand-held computer. The mobile terminal 10 includes a system controller 12 to control overall operation of the mobile terminal 10 and a memory 14 to store program instructions and data needed for operation. The system controller 12 may comprise one or more processors, microcontrollers, hardware, firmware, or a combination thereof. Memory 14 may comprise one or more memory devices, including removable memory devices such as SIM cards and smart cards.

A transceiver 16 coupled to an antenna 18 and under the control of the system controller 12 enables communication with remote devices. The transceiver 16 may, for example, comprise a fully functional cellular transceiver operating according to any known standard. A user interface 20 enables the user to interact with the mobile terminal 10. The user interface 20 includes a microphone 22 for converting audible signals into electrical audio signals, a speaker 24 for converting electrical audio signals into audible sounds, one or more input controls indicated generally by the numeral 30 for receiving user input, and a display 40 to display information for viewing by the user. Any known type of input controls 30 for receiving user input may be used including hard and soft keys, programmable keys, keypads, dials, joysticks, buttons, thumbwheels, touch pads, etc. The selection keys 32 and navigation keys 34 shown in FIGS. 2-5 are exemplary input controls 30. Display 40 may comprise a color display, such as a liquid crystal display (LCD) or a touchscreen display that can also be used for user input.

The messaging application 100 is stored in memory 14 and executed by the system processor 12. Memory 14 further stores cost information, which may be in the form of a cost table 112, that is accessed by the cost estimation function 106 to estimate the cost of messages. In one exemplary embodiment, the cost table 112 is stored in a SIM card or other removable memory device. The cost table 112 is downloaded into memory 14 during device provisioning, which may occur over-the-air. The service provider can update the cost table 112 whenever the pricing for messaging services changes or when the user changes service plans. The cost table 112 contains cost information for all messaging services, and may include information on roaming costs and time-of-day pricing.

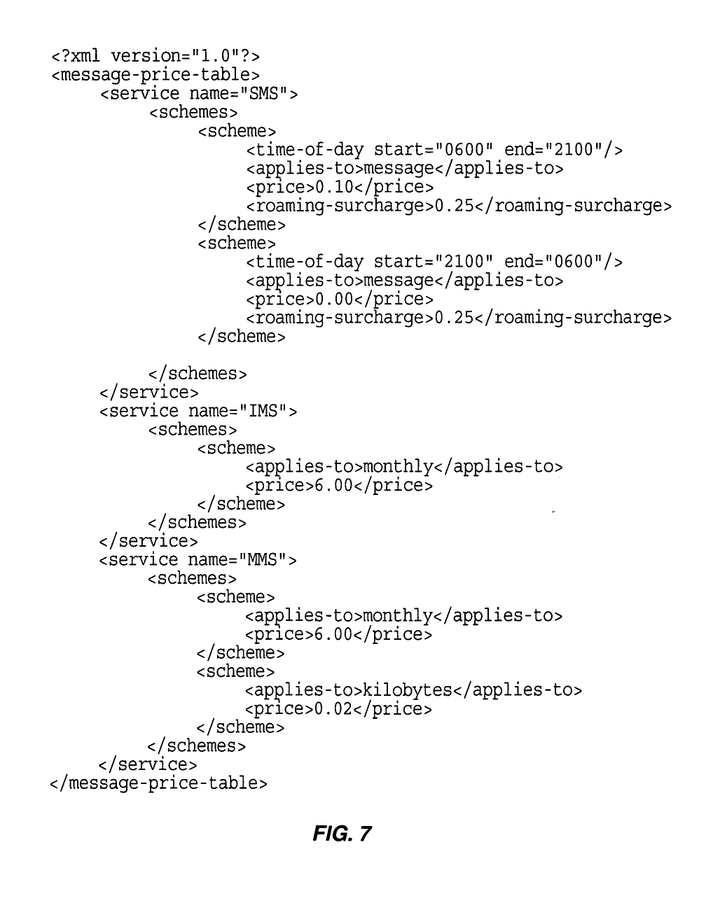

FIG. 7 illustrates an exemplary cost table 112 implemented as an XML script. The cost table 112 in FIG. 7 represents a hypothetical pricing structure for SMS, MMS and IMS services. Between 6:00 am and 9:00 pm, SMS messages cost 10 cents per message, with a 25 cent roaming surcharge for roaming. From 9:00 pm to 6:00 am, SMS messages are free, but the roaming surcharge still applies. IMS is charged at a fixed rate of $6.00 per month. MMS is charged at a fixed rate of $6.00 per month, plus an additional 2 cents per kilobyte. Thus, it can be seen that the present invention accommodates any arbitrarily complex pricing structure.

While the implementation of the cost table as an XML document provides a convenient method for updating the cost table, those skilled in the art will appreciate that the cost table could be implemented in other ways. For example, the cost table could be implemented as a database table, associative hash table, or other data structure.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A mobile communication device, comprising:
a processor;
a memory;
a messaging application stored in said memory and executed by said processor for sending and receiving messages, said messaging application including a message composer for creating messages to be sent;
a cost estimation function integrated with said message composer for estimating the cost of said messages and for indicating the cost of said messages to a user.

2. The mobile communication device of claim 1 wherein the mobile communication device further comprises a display and wherein the messaging application includes a graphical user interface that is displayed to the user on said display.

3. The mobile communication device of claim 2 wherein the graphical user interface displays the estimated cost of a message to be sent.

4. The mobile communication device of claim 3 wherein the graphical user interface comprises an application window and wherein the estimated cost of the message is displayed in a portion of the application window.

5. The mobile communication device of claim 4 wherein the estimated cost is displayed in one of a title bar, menu bar, or status bar of the application window.

6. The mobile communication device of claim 3 wherein the estimated cost is displayed to the user in a pop-up window.

7. The mobile communication device of claim 3 wherein the messaging application prompts the user to send the message after displaying the estimated cost.

8. The mobile communication device of claim 7 wherein the estimated cost and prompt are displayed together in a pop-up window.

9. The mobile communication device of claim 8 wherein the messaging application is configured to selectively suppress the pop-up window based on a predefined criterion.

10. The mobile communication device of claim 9 wherein the messaging application suppresses the pop-window when the cost of a message is less than a predetermined amount.

11. The mobile communication device of claim 9 wherein the messaging application suppresses the pop-window based on a type of the message.

12. The mobile communication device of claim 9 wherein the messaging application suppresses the pop-window based on time of day.

13. The mobile communication device of claim 1 further comprising a cost table stored in memory and containing cost information for estimating the cost of message to be sent.

14. The mobile communication device of claim 13 wherein the cost table is stored in a removable memory device.

15. A method of providing information to a user of a mobile communication device about the cost of messages being sent, said method comprising:
storing cost information in a memory in the mobile communication device;
estimating the cost of a message to be sent based on said cost information stored in memory; and
displaying the estimated cost of the message to the user before the message is sent.

16. The method of claim 15 wherein displaying the estimated cost of the message comprises displaying the estimated cost on a display.

17. The method of claim 16 wherein the estimated cost is displayed in a graphical user interface.

18. The method of claim 17 wherein the estimated cost is displayed in a portion of an application window of a graphical user interface.

19. The method of claim 18 wherein the estimated cost is displayed in one of a title bar, menu bar, or status bar of the application window.

20. The method of claim 17 wherein the estimated cost is displayed to the user in a pop-up window.

21. The method of claim 20 further comprising prompting the user to send the message after displaying the estimated cost.

22. The method of claim 21 wherein the cost is displayed together with a user prompt in the pop-up window.

23. The method of claim 20 further comprising selectively suppressing the pop-up window based on a predefined criterion.

24. The method of claim 23 wherein the pop-window is suppressed when the cost of a message is less than a predetermined amount.

25. The method of claim 23 wherein the pop-window is suppressed based on a type of the message.

26. The method of claim 23 wherein the pop-window is suppressed based on time of day.

27. The method of claim 15 wherein the cost information is stored in a table.

28. The method of claim 27 wherein the cost table is stored in a removable memory device.

29. A messaging application for a mobile communication device comprising:
a message composer for creating messages of two or more different types;
a cost estimation function for estimating the cost of messages and for indicating the estimated cost to the user.

30. The messaging application of claim 29 wherein the mobile communication device further comprises a display and wherein the messaging application includes a graphical user interface that is displayed to the user on said display.

31. The messaging application of claim 30 wherein the graphical user interface comprises an application window and wherein the estimated cost of the message is displayed in a portion of the application window.

32. The messaging application of claim 31 configured to display the estimated cost in one of a title bar, menu bar, or status bar of the application window.

33. The messaging application of claim of 32 configured to display the estimated cost in a pop-up window.

34. The messaging application of claim 33 configured to prompt the user to send the message after displaying the estimated cost.

35. The messaging application of claim 34 configured to display the estimated cost and prompt together in the pop-up window.

36. The messaging application of claim 33 configured to selectively suppress the pop-up window based on a predefined criterion.

37. The messaging application of claim 36 configured to suppress the pop-window when the cost of a message is less than a predetermined amount.

38. The messaging application of claim 36 configured to suppress the pop-window based on a type of the message.

39. The messaging application of claim 36 configured to suppress the pop-window based on time of day.

40. The messaging application of claim 29 including a cost table stored in memory containing cost information for estimating the cost of message to be sent.

41. The messaging application of claim 40 wherein the cost table is stored in a removable memory device.
